(19) United States
(12) Patent Application Publication
(10) Pub. No.: US 2004/0099531 A1
(43) Pub. Date: May 27, 2004

(54) Methods and apparatus for electrochemically testing samples for constituents

(76) Inventors: Rengaswamy Srinivasan, Ellicott City, MD (US); Hassan M. Saffarian, Silver Spring, MD (US); Andrew B. Feldman, Columbia, MD (US); Plamen Demirev, Ellicott City, MD (US); Peter F. Scholl, Silver Spring, MD (US)

Correspondence Address: THE JOHNS HOPKINS UNIVERSITY, Applied Physics Laboratory, 11100 Johns Hopkins Road, Laurel, MD, 20723-6099, US

(21) Appl. No.: 10/640,985

(22) Filed: Aug. 14, 2003

Related U.S. Application Data
(60) Provisional application No. 60/403,680, filed on Aug. 15, 2002.
(60) Provisional application No. 60/405,270, filed on Aug. 22, 2002.

(51) Int. Cl. G01N 27/26

(52) U.S. Cl. 204/412; 204/407

(57) ABSTRACT

The present invention concerns a sensor array and related testing apparatus for rapidly detecting the presence and/or concentration of constituents in samples, particularly biological molecules in fluid samples, including associated testing methods. The invention can be adapted such that a plurality of the sensors each detect a different constituent so that the invention can rapidly detect multiple constituents in a single sample. The sensors may be arranged in an array and connected by a plurality of micro channels that are fed from a main channel into which the sample is introduced. Positive pressure can be applied to the main and micro channels by a micro-pump. Alternately, it can be adapted to detect one or more constituents in a plurality of separate samples. A plurality of sensors are provided, each comprising electrochemical cells comprising an anode, a cathode and a reference electrode separated from each other by one or more filters within which an electrolyte is suspended. The cathode of each sensor is particularly adapted to optimize adherence to it of the particular constituent that it is designed to detect. The electrodes of each sensor are electrically coupled to a miniature electrochemical analyzer designed to send electrical pulses (voltage or current) to the electrochemical cell, and and measure the response (current or voltage) by the electrochemical cells responsive to the pulses and then analyze the response to determine the presence and/or concentration of the constituents. The transient current or voltage responses are affected by the type and concentration of the constituent that adheres to the cathode of the particular sensor.

### CROSS-REFERENCE TO RELATED APPLICATIONS

The present application claims the benefit of prior filed Provisional Application No. 60/403,680, which was filed with the United States Patent and Trademark Office on Aug. 15, 2002, and prior Provisional Application No. 60/405,270, which was filed with the United States Patent and Trademark Office on Aug. 22, 2002. The entire disclosure of the two above-referenced applications are incorporated herein by reference.

### FIELD OF THE INVENTION

The present invention relates generally to methods and apparatus for electrochemically testing samples for constituents. More specifically, the present invention concerns the detection of biological molecules in fluids.

### BACKGROUND OF THE INVENTION

Methods and apparatus for the efficient and accurate detection and quantification of constituents in fluid samples, such as analyte levels in target samples, are of particular interest for use in a wide range of applications. For example, the effective and efficient detection of heme or hemoglobin in human feces, i.e., fecal occult blood (FOB) detection, is of significant interest in the diagnosis of colorectal cancer. Colorectal cancer has an annual worldwide incidence of more than 600,000 cases and is the third most common human cancer. It has been reported as being the second leading cause of death in North America (Lieberman, et al. “Use of Colonoscopy to screen Asymptomatic Adults for Colorectal Cancer,” New England Journal of Medicine, 343, 162-168 (2000)). Among those over 45 years of age, 10% have colorectal polyps of which 1% will become malignant. Early detection of these lesions increases patient survival rates. Id. The presence of heme or hemoglobin in the feces is an indication of bleeding colon polyps, which are a known risk factor for the developments of colon cancer. By monitoring the levels of heme in human feces, the early detection and treatment of colorectal cancer is more readily achieved.

Other applications for the accumulation and detection of heme include the diagnosis of malarial infection. Malaria infections can result in the accumulation of heme in infected red blood cells. By monitoring the accumulation of heme in red blood cells, early detection of malarial infections can be achieved.

Electrochemical techniques, including cyclic voltammetry (CV), differential pulse voltammetry (DPV), alternating current voltammetry (ACV), and AC impedance (electrochemical impedance spectroscopy or EIS), are well-known qualitative and semi-quantitative electrochemical techniques that can be used to test fluids for analytes. Individual species present in a mixture can be qualitatively identified by their respective reduction and oxidation potentials (redox potentials), if experimental conditions are suitably controlled.

When properly calibrated, DPV or ACV could be used for the semi-quantitative detection of low-analyte concentrations (10⁻⁹ M). Measurement sensitivity can be improved further by absorbing or binding the analyte to a large surface area electrode prior to initiating the reaction.

Methods for accumulating analytes such as iron protoporphyrin and iron hematoporphyrin using dimercaptoalkane-modified solid wire or plate gold electrodes have been disclosed in “Electrochemistry of Self-Assembled Monolayers of Iron Protoporphyrin IX Attached to Modified Gold Electrodes through Thioether Linkage” D. L. Pilloud, et al., J. Phys. Chem. B 2000, 104, 2868-2877 (hereinafter “Pilloud”), incorporated herein by reference. However, as discussed in Pilloud itself, the electrodes produced for use therein are disadvantageous in that the thiolated electrode surfaces tend to degrade relatively rapidly when the electrodes are left in contact with air or immersed in aqueous solution. Id. at 2869. Accordingly, such methods are unsuitable for producing electrodes capable of accumulating analytes for relatively long periods of time (for example one or more days) and for being transported in air or water for any significant period of time. Accordingly, the use of such electrodes is severely restricted or even impossible in many realistic situations. For instance, some practical uses of detection require the electrode to be exposed to the sample for a period of a day or longer; in such cases, the electrode may degrade in less time than is needed to accumulate the analyte on the electrode. Furthermore, field use of the electrode is almost impossible in any real-life situation since it often will be impossible to fabricate the electrode, transport it to the field site for use, use it (i.e., expose it to the sample for the required amount of time), and electrochemically analyze it within the available time before the electrode degrades.

Several products for the detection of heme in a sample are available commercially and used clinically. For example, fecal occult blood detection products are available under the trade names Hemoccult II and Hemoccult II SENSA from Smith Kline Diagnostic, Palo Alto, Calif., and immunochemical detection methods are available under the trade names Hemeselect and FlexSure OBT. Unfortunately, such products lack the desired sensitivity and specificity, and, consequently, the false positive detection rates for fecal occult blood tests is high. One to five percent of all persons tested yield positive results; however, only 2-10% of these have cancer and 20-30% have adenomas. The poor sensitivity and specificities of these assays contribute to high false positive rates. This results in the use of expensive and invasive colonoscopic examinations that could be obviated if more specific and sensitive fecal blood detection methods were available.

### SUMMARY OF THE INVENTION

The present invention concerns a sensor array and related testing apparatus for rapidly detecting the presence and/or concentration of constituents in samples, particularly biological molecules in fluid samples. The invention also concerns associated testing methods. The invention can be adapted such that a plurality of sensors each detect a different constituent so that the invention can rapidly detect multiple constituents in a single sample. Alternately, it can be adapted to detect one or more constituents in a plurality of separate samples.

A plurality of sensors are provided, each comprising an electrochemical cell having a working electrode (WE), a counter electrode (CE) and a reference electrode (RE) separated from each other by one or more filter papers within which an electrolyte is absorbed. The working electrode of each sensor is particularly adapted to optimize adherence to it of the particular constituent that is to be detected. The electrodes of all of the sensors are electrically coupled to a miniature electrochemical analyzer designed to send electrical pulses to the working electrodes of the sensors and detect and measure the current transients through each of the sensor electrochemical cells responsive to the pulses in a multiplexed fashion and then analyze the current transients to determine the presence and/or concentration of the constituents in each sensor.

n an embodiment adapted for testing a single sample for multiple constituents, the sensors are arranged in an array fluidly connected by a plurality of micro-channels that are fed from a main channel into which the sample is introduced. Positive pressure may be applied to the interconnected micro-channels by a micro-pump. Each sensor may comprise a glass or plastic capillary coupled at one end to one of the micro-channels of the array and includes a glass frit to filter the sample before it reaches the working electrode, a paper filter layer within which is disposed a reference electrode, another paper filter, and the counter electrode. The working electrode of each sensor cell in the array may be treated with a different treatment to enhance binding thereto of a different constituent. A micro-heater may be coupled to each sensor to allow heating of the sensor to the optimum temperature for causing the particular constituent to bind to the cathode.

In other embodiments adapted for testing multiple, separate samples for a single constituent, each sensor is identical (e.g., the working electrodes of all the sensors are chemically treated with the same treatment to optimize binding thereto of the same constituent) and the sensors are not fluidly interconnected to each other. The samples can be fed to the sensors manually by dropper or similar technique without the use of a pump.

### BRIEF DESCRIPTION OF THE DRAWINGS

FIG. 1 is a schematic drawing of an electrochemical sensor array in accordance with a first embodiment of the present invention particularly adapted for testing a single sample for multiple constituents.

FIG. 2 is a schematic drawing of a sensor cell in accordance with the present invention particularly suitable for the embodiment of FIG. 1.

FIG. 3A is a graph showing an exemplary pulse train for exciting the working electrode of a sensor in accordance with the present invention.

FIG. 3B is a graph showing an exemplary transient current response to the pulse train of FIG. 3A for an exemplary sample.

FIG. 4 is a graph showing charge calculated as a function of potential for an exemplary sample based on the data shown in FIGS. 3A and 3B, from which the presence and concentration of the tested for constituent can be derived in accordance with the present invention.

FIG. 5 is a schematic drawing of an electrochemical sensor array in accordance with another embodiment of the present invention particularly adapted for testing multiple samples for one or more constituents.

FIG. 6 is a graph showing the electrical charge obtained from ACV data versus heme concentration for a first experimental application of the present invention.

FIG. 7 is a graph showing the electrical charge obtained from ACV data for malaria-infected blood sample tested on a thiolated gold electrode for a second experimental application of the present invention.

### DETAILED DESCRIPTION

The present invention is an apparatus for testing a sample, particularly a fluid sample, and more particularly a liquid sample, for a constituent. The invention is particularly adapted for application in the medical field, such as for detecting a biological molecule in a fluid sample, e.g., an analyte in a bodily fluid. A primary impetus for the present invention is the need for a testing apparatus and method in which a large population of samples can be simultaneously tested and/or a single, larger volume sample can be simultaneously tested for multiple biological molecules. As will become clear, the present invention is particularly suitable for testing for heme in human feces, i.e., fecal occult blood (FOB) detection, which is useful for detecting colo-rectal cancer in humans. However, it has many other applications.

As noted above in the Background section of this specification, AC voltammetry (ACV) and differential pulse voltammetry (DPV) are known electrochemical techniques used to detect analytes, such as heme, or other electro-active constituents in a sample. Particularly, a working electrode can be exposed to a sample, e.g., a fluid sample, that may contain a constituent to be tested for. The electrode is treated or coated with a compound to which the constituent of interest will bind. The presence of the constituent of interest on the electrode changes the electrical properties of the electrode. The electrode is then introduced into an electrochemical cell with at least one other electrode, i.e., a counter electrode (and typically also a third electrode, called the reference electrode). An electrical stimulus (voltage or current) is applied to the cell through the counter electrode. The response (current or voltage) by the cell is sensed at the working electrode; voltages are measured between the working electrode and the reference electrode. The response to the electrical input stimulus is, in theory, indicative of the presence or absence and/or the concentration of an electro-active constituent of interest. Co-pending U.S. patent application Ser. No. ______ (Attorney Docket No. 1845-SPL) discloses a novel working electrode and a method of making such an electrode that has substantially improved properties compared to conventional electrodes. Particularly, as previously noted, a problem with conventional electrodes is that the coating or treatment that is particularly adapted to cause the electro-active constituent of interest to bind to the electrode degrades extremely quickly, typically, within no more than a day or two of coating. Accordingly, the coating had to be applied, the electrode exposed to the sample, and the electrochemical analysis completed all within one or two days.

Aforementioned U.S. provisional patent Application No. 60/405,720 as well as U.S. non-provisional patent Application No. ______ (Attorney Docket No. 1845-SPL), describe procedures to concentrate species such as heme from low concentration (10⁻⁹M) solutions onto electrode surfaces (metal, carbon, doped-silicon and conducting-polymers) that can be used to produce working electrodes for DPV or ACV in which the coating lasts a substantially longer period of time than previously possible. Accordingly, that invention substantially enhances the ability of medical personnel to use DPV or ACV in the field.

The present invention is a sensor array particularly suited for simultaneously testing a large number of samples (e.g., about 100 samples each of less than 10 micro liter sample volume) in the field, or, alternately, simultaneously testing a single, large sample (e.g., about 1 milliliter sample volume) for a large number of different constituents in the field. Although the present invention as described in more detail below can be used with conventional working electrodes, the combination of the electrodes disclosed in aforementioned U.S. patent application Ser. No. ______ (Attorney Docket No. 1845-SPL) with the present invention substantially enhances the ability to perform large-scale field testing for biological molecules or other constituents in samples.

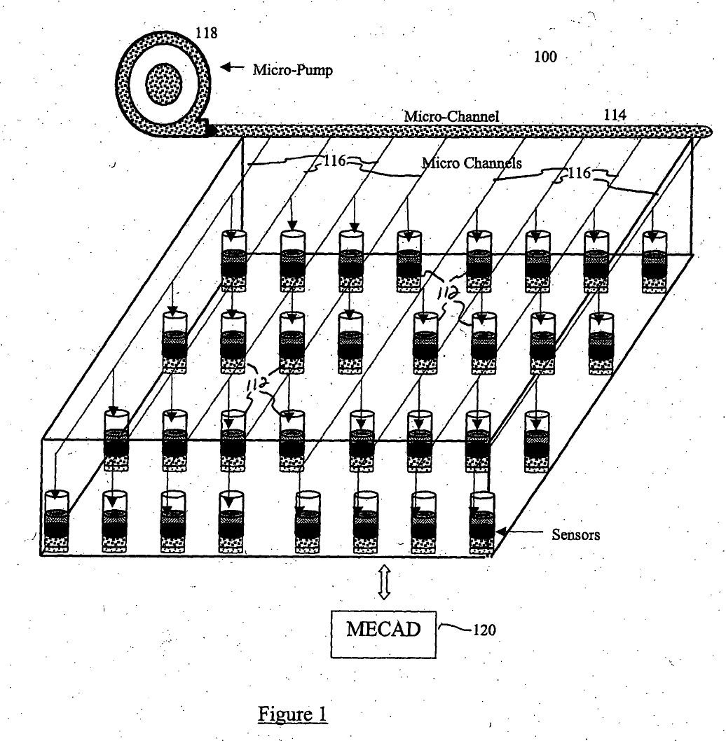

FIG. 1 is a schematic diagram of a first embodiment of the present invention. The testing apparatus 100 comprises a plurality of electrochemical sensors 112 arrange in an array, such as in rows and columns. FIG. 1 shows an embodiment of the invention particularly adapted for testing a single, relatively large volume (e.g., about 1 milliliter) of a sample for a plurality of different constituents. Each sensor 112 comprises an electrochemical cell to be described in greater detail herein below. The working electrode (WE) of each cell is coated with a different compound particularly adapted to enhance the binding to the electrode of a different constituent to be tested for. Alternately, one or more of the WEs may be coated with the same compound so that such cells will test for the same constituent. This may be preferable in some cases in order to increase the accuracy of the test results by performing multiple tests for a single constituent and averaging the results over the plurality of tests.

The cells are fluidly coupled to each other and to a reservoir 114 into which the sample can be introduced by a plurality of micro-channels 116. The micro-channels may be formed of interconnected glass or plastic tubes. Merely as an example, in an embodiment adapted to test for heme in human feces, in which sample volumes can be expected to be on the order of 100 microliters, micro-channels may have inner diameters of about 100 to 200 micrometers. The sample is introduced into the reservoir 114 and flows through the micro-channels into the sensor cells 112. In order to enhance the speed with which the constituents in the fluid sample bind to the electrodes in the cells, positive pressure may be applied to the reservoir 114, micro-channels 116, and cells 112 by a micro-pump 118. Suitable pumps are known in the art and commercially available, such as Series 110TP: Teflon Micropump-40 μL manufactured by Bio-Chem Valve Inc. of Boonton, N.J., USA). In the particular embodiment illustrated schematically in FIG. 1, the micro-pump 118 is coupled to the reservoir 114. However, the micro-pump can be fluidly coupled into the fluid system of the reservoir, micro-channels and cells at any location.

The various electrodes of the various cells are electrically coupled to a miniature electrochemical analyzer 120 (the individual electrical connections to each sensor and electrode is not represented in FIG. 1). The miniature electrochemical analyzer 120 applies electrical impulses to the CEs of the cells and then reads the electrical response thereto. In accordance with well-known DPV or ACV analytical techniques, the current response by the sensors to the input voltage impulse, as measured at the working electrode can be analyzed to determine the presence or absence of the particular constituent being tested for in that sensor cell and/or the concentration thereof.

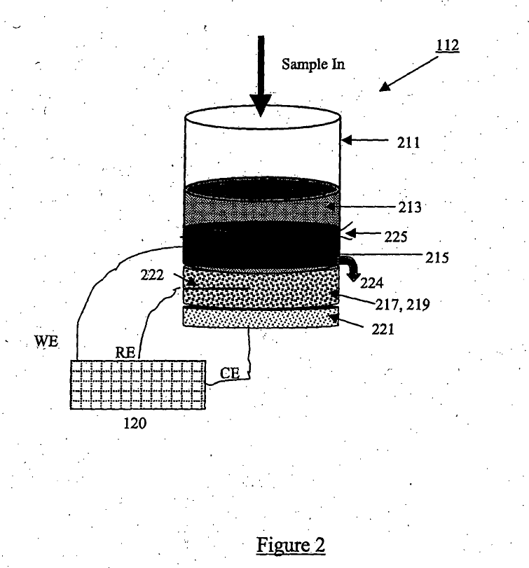

FIG. 2 is a detailed schematic of an individual sensor cell 112 in the array illustrated in FIG. 1. The sensor cell consists of a glass or plastic capillary 211. The capillary 211 may be cylindrical and contains essentially all of the other elements described herein below. The sample enters the sensor cell from the micro-channels through the top of the capillary 211. Within the capillary is a glass frit 213, which filters undissolved constituents from the sample before it reaches the electrically active portion of the sensor cell. Beneath the glass frit 213 is the sensitized working electrode 215, preferably manufactured in accordance with the invention described in aforementioned U.S. patent application Ser. No. _____ (Attorney Docket No.1845-SPL). Briefly, the working electrode may be formed of wire and, particularly, gold wire. However, other metals and alloys such as platinum, stainless steel and even non-metals, including, carbon, doped silicone, and conductive polymeric materials can be used as the electrode for the accumulation of constituents. In at least one embodiment of the invention, the working electrode comprises a thin (25- to 100-micron-diameter; 1-meter-long) gold wired coiled around a 0.25 to 0.5-mm-diameter gold support wire. In other embodiments of the invention, the working electrode may be formed of a powdered gold bound together by adhesive. The adhesive may be a mixture of carbon powder and polytetraflourethylene adhesive. Treating the electrode surface first with dithiol as set forth in application Ser. No. ______ (Attorney Docket No. 1845-SPL) sensitizes the surface to heme. Dithiol also equally sensitizes other surfaces to heme. The dithiol molecules have an inherent property to bind those surfaces at one end and to heme molecules on the other end. The dithiol molecules not only help to accumulate heme from the solution onto the electrode surface, but also aid the electronic transfer process between the heme and the electrode. Hence, they are also known as “linkers”. If the species to be detected is other than heme, the surface should be sensitized with other types of linkers specific to the analyte or other constituent to be tested for in the solution. A recent review article by Luppa et al. (P. B. Luppa, L. J. Sokoll and D. W. Chan, “Immunosensors-principles and applications to clinical chemistry, Clinica Chimica Acta, Vol. 314, Year 2001, pp. 1-26.) and references therein provide descriptions of linkers suitable for various analytes commonly encountered in biological solutions.

Beneath the working electrode 215 are a pair of filter papers 217, 219, which are wet with an aqueous solution of one or more salts (example: 0.1 M KCl or a mixture of 0.1M KCl+0.01 M HEPES+0.3% v/v DMSO) that serves as the electrolyte for the electrochemical cell. The sensitized working electrode 215 may be formed from a mesh or compacted powder and may be formed into a spiral in order to increase its surface area and, thus, the amount of the constituent under test that will bind to it.

The bottom of the lower filter paper is coated with graphite powder that forms the counter electrode (CE) 221. A reference electrode (RE) 222 is disposed between the two filter papers 217 and 219. In a preferred embodiment of the invention, the reference electrode is formed of silver/silver chloride. Accordingly, the sensitized electrode, counter electrode, and reference electrode, along with the filter papers wet with the electrolyte, form the electrochemical cell 112. Preferably, the capillary 211 includes a hole 224 adjacent the sensitized electrode 215 through which excess sample solution may exit the capillary, if necessary.

In a preferred embodiment of the invention, each cell further includes a micro-heater 225 adapted to heat the cell 112 (particularly, the sensitized electrode) to an optimum temperature for causing the constituent under test to bind to the working electrode. In addition, preferably, the pressure applied by the micro-pump 118 is adjustable so that the pressure may be set to achieve the optimum pressure and/or flow rate for causing the constituent to adhere to the electrodes.

As previously mentioned, the three electrodes in each cell are coupled to the miniature electrochemical analytical detector (MECAD) 120 so that the MECAD can apply electric stimulus to the cell, e.g., in the form of pulses, and detect and analyze the transients responsive thereto for purposes for determining the presence and/or concentration of the particular constituents being tested for. The transient responses of the cell are used for purposes of analyzing the results and calculating therefrom whether the constituent under test is present in the sample and/or in what concentration.

Referring back to FIG. 1, in operation, the sample solution is introduced into the reservoir114 in any reasonable fashion. For instance, the reservoir may be adapted to accept sample squirted out of the end of a hypodermic needle or dropper. The reservoir is closed (either automatically, such as through self-sealing, or manually). The micro-pump 118 is turned on and positive pressure applied by the pump to the reservoir 114, micro-channels 116 and sensor cells 112 causes the fluid sample to flow into the sensor cells and over the surfaces of the working electrodes 215. The glass frit 213 above the sensitized electrode filters undissolved particles from the sample solution before it reaches the working electrode. Some of the sample solution will also wet the filter papers and also overflow the cells through the hole 224. As the sample flows over the electrode, the constituent that the coating on the electrode is particularly adapted to bind to will bind to the electrode, if any is present.

Once the solution has been passed through the cells for the time, and at the pressure and temperature chosen to maximize binding of the constituents to the working electrodes, the MECAD then applies suitable electrical input impulses to the cells, and observes the electrical responses thereto across the working, counter and reference electrodes.

With special reference to FIGS. 3A and 3B, in an exemplary application of the invention, a series of potential pulses (E₁, E₂, E₃, E₄ . . . ) are applied to the sensitized electrode from its initial potential Eᵢₙᵢₜᵢₐₗ. (See FIG. 3A.) The potential pulses cause a current transient (I-t) to flow through the cell. The amplitude of the current transient depends on the magnitude of the pulse Eᵢ, the presence or absence of the constituent under test on the electrode, and the concentration of the constituent under test on the electrode. FIG. 3B illustrates exemplary current response to the four input pulses of increasing magnitude E₁, E₂, E₃, and E₄.

At each Eᵢ, the current transient is integrated to derive the electrical charge Q. An asymptotic increase in Q as a function Eᵢ indicates the presence of the electro-active constituent under test in the sample solution. The potential at half the value of Q is characteristic of the species and the maximum amplitude of Q provides an estimate of the concentration of the species on the electrode surface.

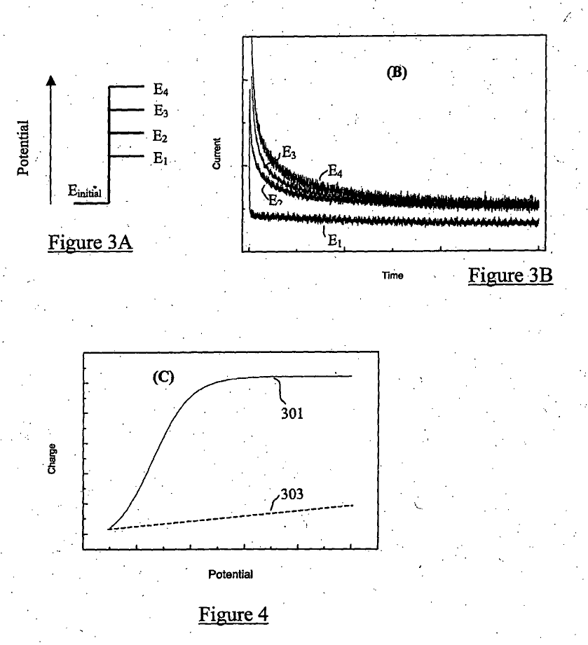

FIG. 4 is a graph showing charge Q plotted against the potential of the impulse to which the calculated charge is responsive. Line 301 indicates the presence of the constituent under test as it shows an asymptotic increase in Q versus E. In the absence of any electro-active species, Q increases monotonically with E, as illustrated by the dashed line 303 in FIG. 4.

The circuitry, algorithms, and/or software suitable for performing the analytical tasks that must be performed by the MECAD are essentially conventional and would be known to those of skill in the art. The MECAD circuitry can comprise analog circuitry, digital circuitry, state machines, microprocessors, programmable logic arrays, combinational logic, computers, and/or combinations thereof. In a preferred embodiment of the invention, the MECAD is embodied on a single microelectronic chip (or chip set comprising a small number of microelectronic chips) in order to allow the apparatus of the present invention to be as small and as portable as possible. In a preferred embodiment of the invention, the MECAD is coupled to the electrodes of the various sensor cells through a multiplexer so that one set of circuitry for performing the analysis can perform the analysis in a multiplexed fashion on each of the plurality of sensor cells.

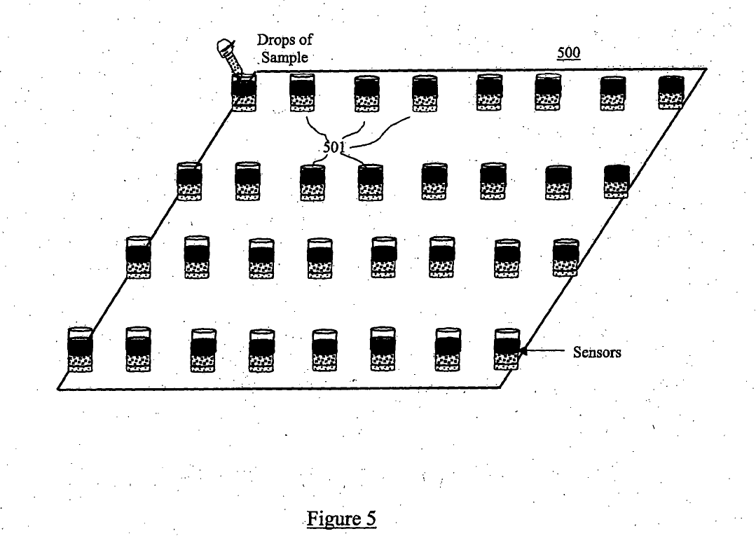

In an alternative embodiment, the invention can be adapted to allow field testing of a large population of samples for a single (or more than one) constituent. FIG. 5 shows a sensor array according to such an embodiment. The apparatus 500 comprises a plurality of electrochemical cells 501, which, again, may be arranged in a plurality of rows and columns. However, the electrochemical cells are not inter-coupled by micro-channels. Rather, each electrochemical cell 501 is fluidly separated from every other electrochemical cell so that each cell can be used to test a different sample. Individual cells may be the same as those shown in FIG. 2, however, in embodiments in which there is no fluid sample supply structure (such as the micro-channels), and that the cell comprises only the three electrodes and the two filter papers held together by a glass capillary.

As in the previous embodiment, each electrode in each cell is coupled to the MECAD.

The samples may be introduced onto the sensitized electrode by any reasonable means, such as by dropper or hypodermic needle.

This embodiment can be used to simultaneously test a plurality of separate samples. The sensitized electrode in each cell may be sensitized to bind to the same constituent such that the testing array can be used to test a plurality of samples for the same constituent. Alternately, each cell can be sensitized to bind with a different constituent. Any hybrid variation in between also is possible, i.e., any number of the cells can have sensitized electrodes adapted to bind with the same or a different constituent than any other cell.

Embodiments of the present invention that are hybrids between the embodiments shown in FIGS. 1 and 5 are envisioned for situations in which it may be desirable to quickly test a number of different people/samples for a number of different constituents.

The present invention should reduce the number of false positive fecal occult blood detections while simultaneously increasing the sensitivity of occult blood detection in colo-rectal cancer screening programs. This should reduce the number of unnecessary colonoscopies performed, resulting in significant savings on health care.

While the invention has been described herein above primarily in connection with the detection of biological molecules, and particularly analytes, such as heme, the invention can be applied to detect any electro-active chemical constituent.

An arrayed electrochemical detection system in accordance with the present invention may also find application in the screening of human populations for malaria infection. Experimental evidence is emerging that “free” heme in blood samples can be used to detect malaria infection. Accumulation of heme in red blood cells occurs during malaria infection in humans and animals. The total volume of a sample that may be available for testing for heme can be as small as a few microliters of blood. It is not uncommon to conduct tests for malaria and other blood-affecting pathogens from a large population, in which case, it is desirable to have an arrayed detector system for fast and efficient screening of multiple species in multiple samples.

### EXAMPLE #1

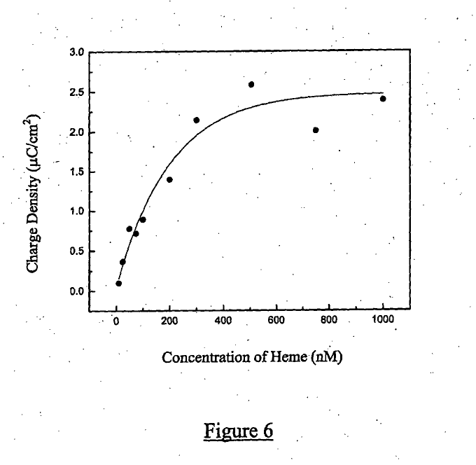

FIG. 6 is a graph showing the electrical charge obtained from ACV data versus heme concentration from an actual test performed using heme dissolved in 0.1 M KCl+HEPES+0.3% v/v DMSO, and tested using a series of thiolated gold electrodes in accordance with the present invention. ACV tests were conducted at various concentrations of heme, in the range of 2×10⁻⁹ to 1×10⁻⁶ M. The amplitude of the AC current is proportional to the concentration of the analyte (heme) in the solution. For each concentration of the heme, the charge associated with the AC current was integrated, and the charge versus concentration is shown in FIG. 6.

### EXAMPLE 2

The ability to detect ultra low concentrations of heme and hemoglobin in bodily fluids has great value in clinical and medical diagnostic applications. The detection system described herein is useful for screening blood and other bodily fluids for the presence of heme or hemoglobin. For example, heme in blood, unbound to other protein, may be an indicator of malaria infection. Heme is released and concentrated into a crystalline form (malaria pigment) inside red blood cells during the malaria parasite's catabolism of hemoglobin. The present invention utilizes electrochemical principles to detect ultra low concentrations of heme in the presence of physiological concentrations of hemoglobin. The sensor array consists of carefully cleaned and uniformly-thiolated, high-surface-area gold electrodes. The electrodes adsorb and concentrate trace amounts of heme present in the sample. The adsorbed molecules are detected and characterized by electrochemical techniques such as AC Voltammetry (or ACV) and differential pulse voltammetry (or DPV).

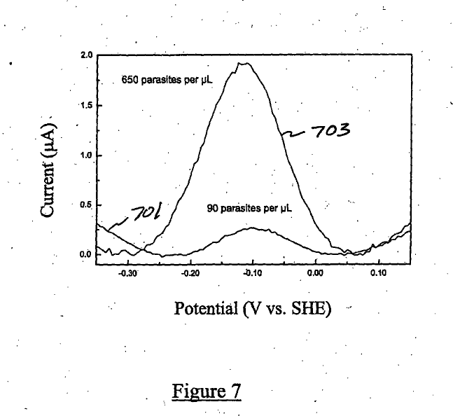

FIG. 7 is a graph showing the electrical charge obtained from ACV data for malaria-infected blood sample tested on a thiolated gold electrode for a second experimental application of the present invention. The figure shows the ACV signals for blood containing about 90 and 650 malarial parasites per microliter of blood, respectively, in traces 701 and 703. The present invention matches the detection limits of 100 parasites per microliter of blood sample set as the benchmark by the World Health Organization to diagnose malaria.

The present invention can also be used for other medical applications in which the presence of blood is of diagnostic value, such as screening for the urinary form of shistosomiasis.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. An apparatus for testing a sample for constituents comprising;
a plurality of electrochemical sensors, each sensor adapted to detect a different constituent within the sample;
a reservoir for containing the sample;
a plurality of interconnected channels fluidly coupling the reservoir to the sensors; and
a circuit coupled to the plurality of sensors to analyze the electrochemical properties of the sensors to detect the presence of a particular constituent at each sensor.

2. The apparatus of claim 1 further comprising a pump fluidly coupled to said reservoir and a plurality of interconnected channels for applying positive pressure to the reservoir and plurality of interconnected channels.

3. The apparatus of claim 2 wherein the pump is a micro-pump.

4. The apparatus of claim 2 further comprising a microheater coupled to each sensor to heat the sensor.

5. The apparatus of claim 2 wherein the circuit for detecting further determines the concentration of the constituent in the sample.

6. The apparatus of claim 1 wherein each sensor is adapted to detect a different constituent.

7. The apparatus of claim 1 wherein the electrochemical sensors each comprise an electrochemical cell comprising:
a working electrode with a coating selected to bind with a particular electro-active constituent;
a counter electrode;
a reference electrode;
filter paper disposed so as to separate between the electrodes from each other; and
an electrolyte in said filter paper.

8. The apparatus of claim 7 wherein the electrochemical cell further comprises a glass frit disposed between the channels external of the sensor and the electrodes of the sensor and a capillary housing the other elements of the sensor.

9. The apparatus of claim 7 wherein the working electrode is disposed closest to the channel through which sample enters the sensor, the counter electrode is disposed furthest from the channel through which sample enters the sensor, and the reference electrode is disposed between the other two electrodes, and wherein the capillary includes an opening disposed adjacent the working electrode through which excess sample can exit the cell.

10. The apparatus of claim 1 wherein the circuit comprises analytic circuitry for analyzing the electrochemical properties of the sensors, a multiplexer, and circuitry for controlling the multiplexer to selectively electrically couple the analytical circuitry to each of the sensors, whereby the analytical circuitry can be used to analyze each sensor distinctly.

11. The apparatus of claim 10 wherein the circuit is embodied on a single microcircuit.

12. The apparatus of claim 10 wherein the analytic circuitry is selectively electrically coupled to the working electrode, reference electrode and counter electrode of each sensor cell and is adapted to apply a series of electrical pulses to the cell and measure the transient responses through the cell to each of the pulses.

13. The apparatus of claim 12 wherein the analytic circuitry is further adapted to integrate each current transient response to a pulse and derive electrical charge Q as a function of the magnitude of the corresponding pulse.

14. The apparatus of claim 1 wherein the channels are micro-channels.

15. The apparatus of claim 7 wherein the coating of the working electrode is adapted to bind with heme molecules.

16. The apparatus of claim 15 wherein the coating comprises dithiol.

17. The apparatus of claim 16 wherein the working electrode comprises a 25 to 100-micron-diameter, 1-meter long gold wired coiled around a 0.25 to 0.5-mm-diameter gold support wire.

18. The apparatus of claim 16 wherein the working electrode comprises a powdered gold bound together by adhesive.

19. The apparatus of claim 18 wherein the adhesive is a mixture of carbon powder and polytetraflourethylene adhesive.

20. An apparatus for testing a sample for constituents comprising;
a plurality of electrochemical sensor cells, each sensor cell adapted to detect a different constituent within the sample; and
an analytic circuitry for analyzing the electrochemical properties of the sensors;
a multiplexer; and
control circuitry for controlling the multiplexer to selectively electrically couple the analytical circuitry to each of the sensors, whereby the analytical circuitry can be used to analyze each sensor distinctly.

21. The apparatus of claim 20 wherein the analytic circuit, multiplexer and control circuit are embodied on a single microcircuit chip.

22. The apparatus of claim 21 wherein the electrochemical sensors each comprise an electrochemical cell comprising:
a working electrode with a coating selected to bind with a particular electro-active constituent;
a counter electrode;
a reference electrode;
filter paper disposed so as to separate between the electrodes from each other; and
an electrolyte in said filter paper.

23. The apparatus of claim 22 wherein the analytic circuitry is selectively electrically coupled to the working electrode, reference electrode and counter electrode of each sensor cell via the multiplexer and is adapted to apply a series of electrical pulses to the cell and measure the transient responses through the cell to each of the pulses.

24. The apparatus of claim 23 wherein the analytic circuitry is further adapted to integrate each current transient response to a pulse and derive electrical charge Q as a function of the magnitude of the corresponding pulse.

25. The apparatus of claim 24 wherein the circuit for detecting further determines the concentration of the constituent in the sample.

26. The apparatus of claim 21 further comprising a microheater coupled to each sensor cell to heat the sensor cell.

27. The apparatus of claim 20 wherein the electrochemical sensors each comprise an electrochemical cell comprising:
a working electrode with a coating selected to bind with a particular electro-active constituent;
a counter electrode;
a reference electrode;
filter paper disposed so as to separate between the electrodes from each other; and
an electrolyte in said filter paper;
wherein each working electrode has the same coating, whereby each sensor tests for the same constituent.

28. The apparatus of claim 16 wherein the working electrode comprises a 25- to 100-micron-diameter, 1-meter-long gold wired coiled around a 0.25 to 0.5-mm-diameter gold support wire.

29. The apparatus of claim 22 wherein the working electrode comprises a powdered gold bound together by adhesive.

30. The apparatus of claim 28 wherein the adhesive is a mixture of carbon powder and polytetraflourethylene adhesive.

31. A method for testing a sample for constituents comprising the steps of:
providing a plurality of electrochemical sensors, each sensor adapted to detect a different constituent within the sample;
providing a circuit coupled to the plurality of sensors to analyze the electrochemical properties of the sensors to detect the presence of a particular constituent at each sensor;
introducing a sample into each sensor; and
simultaneously analyzing the electrical properties of each electrochemical sensor to detect the presence of at least one constituent in the sample at each sensor.

32. The method of claim 31 wherein each sample is a part of the same larger sample.

33. The method of claim 32 wherein each sensor comprises a working electrode with a coating selected to bind with a particular electro-active constituent, a counter electrode, and a reference electrode, and wherein the working electrode of each sensor has a different coating, whereby each sensor can be analyzed to detect a different constituent.

34. The method of claim 33 further comprising the steps of:
providing a reservoir for containing the sample;
providing a plurality of interconnected channels fluidly coupling the reservoir to the sensors.

35. The method of claim 34 further comprising the step of:
applying positive pressure to force the samples into the plurality of sensors.

36. The method of claim 31 wherein each sensor is adapted to detect a different constituent.

37. The method of claim 31 wherein a different sample is introduced to each sensor.

38. The method of claim 31 wherein the analyzing step further comprises the step of:
simultaneously determining the concentrations of the plurality of constituents in the sample at each sensor.

39. The method of claim 31 wherein the detecting step comprises the steps of:
selectively coupling the circuit to each sensor and analyzing each sensor sequentially.

40. The method of claim 31 wherein each sensor comprises a working electrode with a coating selected to bind with a particular electro-active constituent, a counter electrode, and a reference electrode, and wherein the detecting step comprises the steps of:
(1) selectively electrically coupling the circuit to the working electrode, reference electrode and counter electrode of one of the plurality of sensors;
(2) applying a series of electrical pulses to the cell;
(3) measuring the electrical response by the cell responsive to each of the pulses;

41. The apparatus of claim 40 wherein the detecting step further comprises the step of:
integrating each current transient response to a pulse and deriving electrical charge Q as a function of the magnitude of the corresponding pulse.
